(19) United States
(12) Patent Application Publication
(10) Pub. No.: US 2020/0181896 A1
(43) Pub. Date: Jun. 11, 2020

(54) CONSTRUCTION SINK AND METHOD FOR USING THE SAME

(71) Applicant: Joseph A. Broussard, Naples, FL (US)

(72) Inventor: Joseph A. Broussard, Naples, FL (US)

(21) Appl. No.: 16/691,935

(22) Filed: Nov. 22, 2019

Related U.S. Application Data
(60) Provisional application No. 62/777,992, filed on Dec. 11, 2018.

(51) Int. Cl. E03C 1/18; B01D 21/00

(52) U.S. Cl. CPC E03C 1/18; B01D 21/0042

(57) ABSTRACT

A construction sink is capable of being connected to an existing water supply, such as an outdoor hose or faucet, such that contaminated water can be discharged outside through a residential or commercial drain line. The construction sink is easily portable and includes a sink for cleaning the various contaminants off of tools or other materials used on a construction site. The construction sink includes a self-contained filtration system that use a series of baffles to filter fluid that has been contaminated during the process of cleaning tools or other materials used on a construction site. As the self-contained filtration system filters the fluid that is contaminated during the cleaning of the tools and materials used on a construction site, it can be connected to pre-existing water and drainage lines found in typical residential or commercial buildings without damaging the lines or causing harm to the environment.

### CROSS REFERENCE TO RELATED APPLICATION

This application claims priority to U.S. Provisional Application No. 62/777,992 filed on Dec. 11, 2018, the content of which is hereby incorporated by reference.

### FIELD OF THE DISCLOSURE

This present disclosure generally relates to a portable construction sink. More particularly, the present disclosure relates to a construction sink, having a self-contained filtering system that is capable of being connected to pre-existing water and drainage supply lines typically found in residential or commercial buildings.

### BACKGROUND OF THE INVENTION

Many construction sites are at remote locations and require workers to work with tools and then clean those tools at the remote location. It is not practical during construction-related work to hose down a tool and let the runoff water collect on the ground or go down to the storm drain system. In addition, such methods are unsafe for the workers who are working on the project, unsafe for people who will eventually be living or working at the site, and harmful to the environment.

Currently, sometimes workers will bring a wheelbarrow to the construction site and clean their tools within the body of the wheelbarrow. However, fluid removal from the tray of a wheelbarrow can be a problem for workers. Often the fluid is contaminated and it is not acceptable just to pour the fluid on the ground. Instead workers are forced to scoop the fluid out with a bucket or roll the wheelbarrow to an appropriate dump area where the contaminated fluid can be dumped. Both of these methods are cumbersome and time consuming and result in decreased productivity for the worker.

Also, if the contaminated water used to clean construction tools is disposed of directly into the plumbing system of a typical residential or commercial building without being filtered it will oftentimes lead to a buildup of contaminants that are commonly found on construction sites, such as cements, glues and epoxies. If enough contaminants are added to the plumbing system the contaminants will build up and solidify within the plumbing system, leaving it susceptible to clogs or backups, and oftentimes, will require that the affected parts of the plumbing system be identified and replaced by a professional at the cost of the owner of the residential or commercial building.

Thus, a construction sink is needed that is easily transportable, easily connectable to pre-existing water and drain lines typically found in residential and commercial buildings, and includes a self-contained filtration system to filter contaminated water used to clean construction tools on a construction site, such that the filtered water can be safely disposed of using the pre-existing drain lines typically found in residential and commercial buildings.

The invention provides such a construction sink. These and other advantages of the invention, as well as additional inventive features, will be apparent from the description of the invention provided herein.

### BRIEF SUMMARY OF THE INVENTION

In one aspect of the present disclosure, a construction sink having a sink portion and a tank portion is provided, the sink portion having a faucet coupled to a fluid source and the sink having a drain. The tank portion includes a first section defined by a first baffle, a second section defined by the first baffle and a second baffle, a third section defined by the second baffle and a third baffle, and a fourth section defined by the third baffle. Fluid is expelled from the faucet and contaminated fluid is collected in the sink before entering the first section of the tank portion via the drain; the fourth section includes an opening configured to connect to a drain line of a residential or commercial building.

According to another aspect, the fourth section includes a second drain configured to connect to a water outlet line of a residential or commercial building.

In another aspect of the present disclosure, the first section includes an opening to a contaminant storage tank.

In yet another aspect of the present disclosure, the second baffle provides an opening along the gravitational bottom of the tank portion, such that fluid is forced to flow along the gravitational bottom of the tank portion when exiting the second section and entering the third section of the tank portion.

In yet another aspect, the first and third baffle do not provide an opening along the gravitational bottom of the tank portion.

In yet another aspect, the construction sink includes a tool cleaner having a body and a cover.

In yet another aspect, the tool cleaner has a nozzle extending into an internal cavity of the body and coupled to a fluid source, such that the nozzle can expel fluid into the internal cavity of the body.

In yet another aspect, the tool cleaner has a drain to allow fluid expelled from the nozzle to exit the tool cleaner into the tank portion of the construction sink.

In yet another aspect, the drain of the tool cleaner is located at the gravitational bottom of the tool cleaner.

In another still further aspect of the present disclosure, a construction sink including a faucet coupled to a pressurized fluid source, a sink for collecting a fluid expelled from the pressurized fluid source by the faucet including a drain located at a gravitational bottom of the sink for draining the fluid into a tank portion of the construction sink is provided. The tank portion of the construction sink includes a first section, a second section, a third section and a fourth section defined by a first baffle, a second baffle and a third baffle. The fourth section includes an outlet that can be coupled to a drain line in a residential or commercial building, such that fluid in the fourth section can be discharged from the drain of the construction sink into the drain line of the residential or commercial building.

In another aspect of the present disclosure, the construction sink includes a tool cleaner including a body that defines an internal cavity, a cover, a coupling rod rotatably coupled to the cover and a nozzle coupled to the pressurized fluid source that extends through the body of the tool cleaner and into the internal cavity of the tool cleaner.

According to yet another aspect, the tool is removably configured to connect to the coupling rod of the tool cleaner.

According to still yet another aspect, the tool is a paint roller.

According to another aspect, the coupling rod is rotatable about an axis of rotation in a first direction and a second direction while the coupling rod is extending into an internal cavity of the tool cleaner.

In another aspect, the drain line in the residential or commercial building is a sink drain pipe.

According to yet another aspect, the drain line of the residential or commercial building is a toilet drain pipe.

According to still yet another aspect, the construction sink includes a second drain in the fourth section, such that the construction sink can be configured to connect to both a sink drain line of a residential or commercial building or a toilet drain line of a residential or commercial building.

In another aspect, a method of filtering a contaminated fluid with a construction sink is provided including connecting a first end of a fluid line to a pressurized fluid source and a second end of the fluid line to a faucet; connecting a first end of a drain pipe to an opening in a tank portion of the construction sink and a second end of the drain pipe to a drainage line in a residential or commercial building; actuating the faucet to expel fluid from the pressurized fluid source; cleaning a tool with the fluid from the pressurized clean fluid source; collecting the fluid used to clean the tool in a sink; draining the fluid used to clean the tool through a drain in the gravitational bottom of the sink; collecting the fluid used to clean the tool in a first section of a tank portion of the construction sink; filtering the fluid used to clean the tool through a first section defined by a first baffle, to a second section defined by the first baffle and a second baffle, to a third section defined by the second baffle and a third baffle, and to a fourth section defined by the third baffle; collecting a filtered fluid in the fourth section of the tank portion; and draining the filtered fluid through the outlet in the fourth section of the tank portion.

According to yet another aspect, the method of filtering a contaminated fluid with a construction sink where the first section includes an opening connected to a contaminant storage tank.

According to yet another aspect, the method of filtering contaminated fluid with a construction sink where the second baffle forms an opening between the second section and the third section along the gravitational bottom of the tank portion.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front perspective view of an embodiment of a construction sink according to one aspect of the present application;

FIG. 2 is a front perspective view of the embodiment of the construction sink of FIG. 1 showing the construction sink in an open position;

FIG. 3 is a side cross-sectional view of the embodiment of the construction sink of FIG. 1;

FIG. 4 is a front perspective view of the tank portion of the construction sink of FIG. 1;

FIG. 5 is a side perspective view of the tank portion of the construction sink of FIG. 1;

FIG. 6 is a side perspective view of the tank portion of the construction sink of FIG. 1 showing the side of the tank portion opposite that illustrated in FIG. 4;

FIG. 7 is a cross-sectional view of the tool cleaner of the construction sink of FIG. 1; and

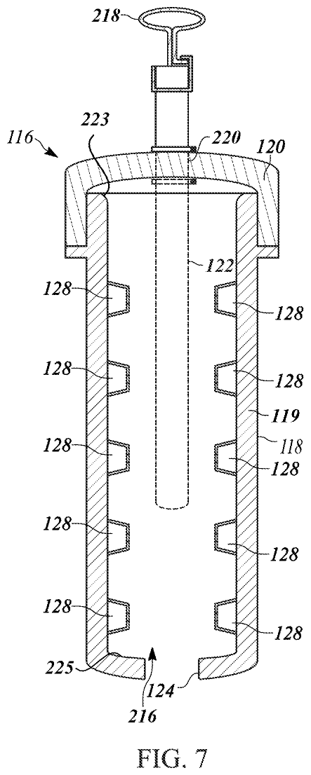

FIG. 8 is a cross-sectional view of the tool cleaner of FIG. 7 illustrating a tool extending into an internal cavity of the tool cleaner and being cleaned by the fluid ejected from the nozzles of the tool cleaner.

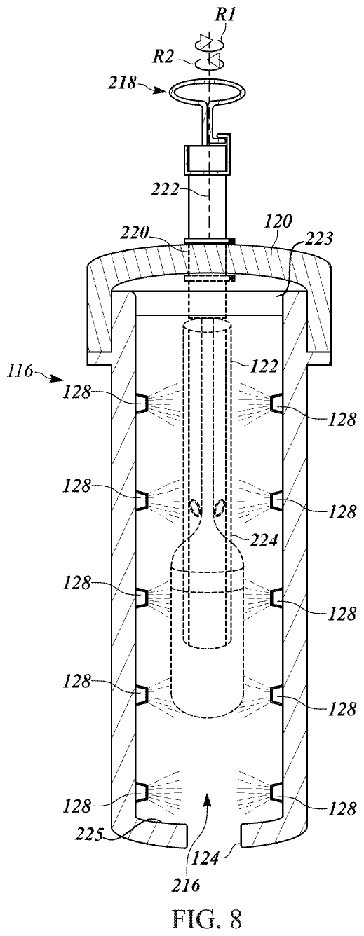

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following disclosure as a whole may be best understood by reference to the provided detailed description when read in conjunction with the accompanying drawings, drawing description, abstract, background, field of the disclosure and associated headings. Identical reference numerals, when found on different figures, identify the same elements or a functionally equivalent element. The elements listed in the abstract are not referenced but nevertheless refer by association to the elements of the detailed description and associated disclosure.

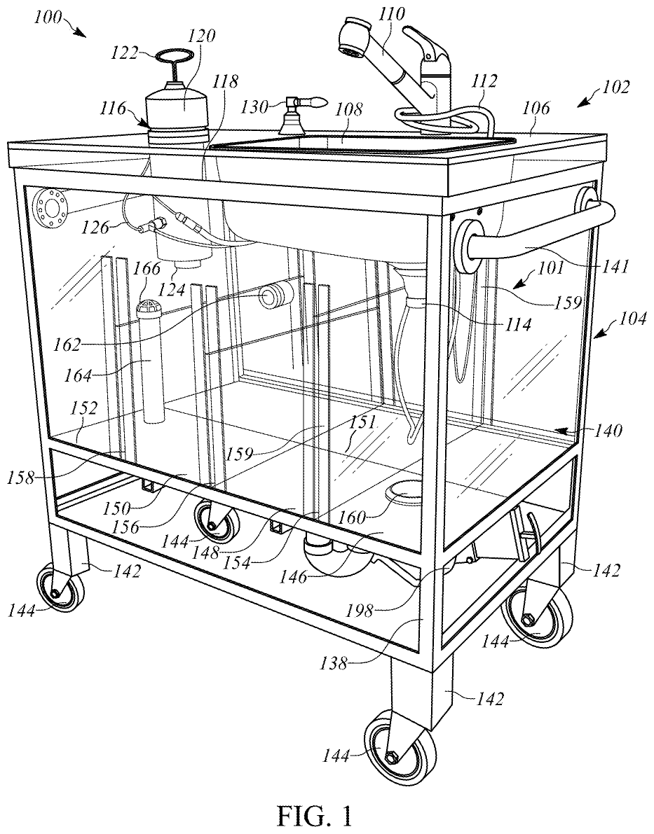

FIG. 1 illustrates one embodiment of a construction sink 100 according to one aspect of the present application. The construction sink 100 includes a top or sink portion 102 and a bottom or tank portion 104. The sink portion 102 includes a top surface 106 that holds a sink 108 and a faucet 110.

The construction sink 100 further includes a fluid line 112 for coupling to a pressurized fluid source at a first end 113 and the faucet 110 at a second end 115. The first end 113 of the fluid line 112 can be configured to couple to any fluid source generally known in the art, such as, but not limited to, the water lines of a residential and/or commercial building. At the gravitational bottom of the sink 108 is a drain 114. As will be understood, the drain 114 provides a means to drain the fluid expelled by the faucet 110 and collected into the sink 108 into the tank portion 104 of the construction sink 100.

The sink portion 102 also includes a tool cleaner 116. The tool cleaner consists of a body 118 and a removable cover 120. The tool cleaner 116 also includes a coupling rod 122 that is rotatably coupled to the cover 120 of the tool cleaner 116, such that the coupling rod 122 extends into the body of the tool cleaner 116 when the cover 120 is placed atop the body 118 of the tool cleaner 116. The tool cleaner 116 also includes a drainage opening 124 located along the gravitational bottom of the body 118 of the tool cleaner 116. As will be understood, the drainage opening 124 provides a means to drain fluids from the tool cleaner 116 directly into the tank portion 104 of the construction sink 100 that is located directly below the drainage opening 124 provided by the tool cleaner 116.

The tool cleaner 116 also includes fluid lines 126 that couple at a first end to a pressurized fluid source, such as, but not limited to, the water line of a residential or commercial building, and at a second end to nozzles 128 that extend through the body 118 of the tool cleaner 116. The flow of fluid from the pressurized fluid source, through the fluid lines 126, and into the nozzles 128 is controlled by the actuation of the rotatable handle 130 located on the top surface 106 of the construction sink 100.

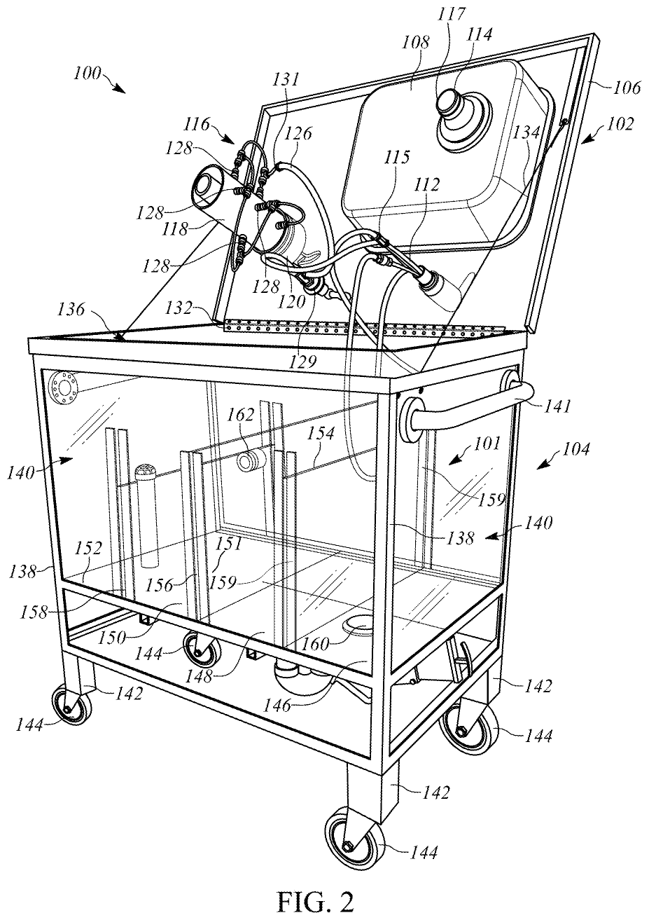

Turning to FIG. 2, the construction sink 100 of FIG. 1 is shown in an open position. As illustrated, the sink portion 102 of the construction sink 100 is mechanically coupled to the tank portion 104 via a bracket 132 and a tension wire 134. The bracket 132 provides a means to rotate the sink portion 102 into the open position and the tension wire 134 provides a means to mechanically secure the sink portion 102 in the open position, which exposes the internal cavity 136 of the tank portion 104 of the construction sink 100.

As will be understood, providing access to the internal cavity 136 of the tank portion 104 via rotating the sink portion 102 to the open position provides the benefit of providing easy access to the components housed within the internal cavity 136 of the tank portion 104 for cleaning or repair.

The tank portion 104 of the construction sink 100 includes a frame 138 that supports the walls 140 of the tank portion 104. As will be understood, the frame 138 and walls 140 can be composed of any fluid-impermeable material that is generally known in the art, such as, but not limited to, any metallic or plastic material.

In one embodiment, the frame 138 is composed of a metal material, such as stainless steel, and the walls 140 are composed of transparent material, such as plexiglass. As will be understood, forming the frame 138 from stainless steel and the walls 140 from plexiglass would provide exceptional structural strength, rust resistance and fluid impermeability for the tank portion 104 of the construction sink 100.

Further, an additional benefit of forming the walls 140 from a transparent material, such as plexiglass, is that it allows a user to monitor the components of the self-contained filtering system housed within the internal cavity 136 without needing to stop use of the construction sink 100 by placing it in an open position (see FIG. 2) to determine if any of the components of the self-contained filtering system may need to be cleaned, repaired or replaced.

The walls 140 of the tank portion 104 also include handles 141, and the frame 138 of the tank portion 104 also includes four legs 142 that are mechanically coupled to wheels 144. As will be appreciated, the handles 141 and wheels 144 provide an easy means to transport the construction sink 100, such that a single person is capable of moving the construction sink 100 to and from a construction site as well as between locations within the construction site.

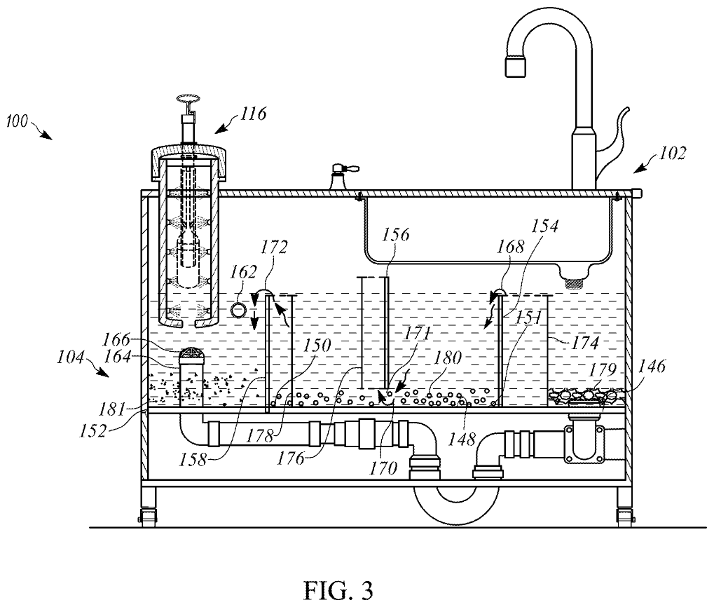

Turning to FIG. 3, a cross-sectional view of the construction sink 100 and with particular reference to the self-contained filtration system within the internal cavity 136 of the tank portion 104 is illustrated. As can be seen, the internal cavity 136 of the tank portion 104 is divided into a first section 146, a second section 148, a third section 150 and a fourth section 152. The first section 146, second section 148, third section 150 and fourth section 152, are generally defined by the walls 140 of the tank portion 104 and a first baffle 154, a second baffle 156 and a third baffle 158, which extend between and form fluid-impermeable barriers with opposing walls 140 of the interior cavity 136 of the tank portion 104.

In one embodiment of the construction sink, the first baffle 154, second baffle 156 and third baffle 158 form a fluid-impermeable barrier by being formed as a single piece with opposing walls 140 of the tank portion 104 of the construction sink 100.

In another embodiment, the first baffle 154, second baffle 156 and third baffle 158 form a fluid-impermeable barrier between opposing walls 140 of the tank portion 104 via being removably inserted into brackets on opposing walls 140 of the tank portion 104 of the construction sink 100. As will be appreciated, using brackets on opposing walls 140 of the tank portion 104 to form a fluid-impermeable barrier between the walls 140 of the tank portion 104 and the first baffle 154, second baffle 156 and third baffle 158 allows a user to adjust the position of the first baffle 154, second baffle 156 and third baffle 158 within the interior cavity 136 of the tank portion 104.

For example and with reference to FIG. 3, if a user wanted to increase the amount of time the fluid being filtered stayed in the first section 146 the user could insert a first baffle 146 having an increased height 174. Likewise, if a user wanted to increase the amount of time the fluid being filtered stayed in the second section 148 the user could insert a second baffle 156 having an increased height 176. Finally, if a user wanted to increase the amount of time the fluid being filtered stayed in the third section 150 a user could insert a third baffle 158 having an increased height 178.

On the contrary, if the user wanted to decrease the amount of time the fluid to be filtered stays in the first section 146 the user could insert a first baffle 154 with a decreased height 174. Further, if the user wanted to decrease the amount of time the fluid to be filtered stayed in the third section 150 the user could insert a third baffle 158 with a decreased height 178. Finally, to decrease the amount of time that the fluid to be filtered remains in the second section 148 the user can insert a second baffle 156 that increases the opening between the second section 148 and the third section 150 along the gravitational bottom of tank portion 104.

As will be appreciated by one of ordinary skill in the art, by increasing the amount of time that the fluid to be filtered stays in the first section 146, the second section 148, the third section 150 or the fourth section 152 will also increase the amount of sediment that will be filtered by that individual section by increasing the amount of time that the gravitational forces are pulling the sediment to the gravitational bottom from each section.

Thus, it is contemplated that a construction sink 100 according to the principles of the present application may have a first baffle 154, second baffle 156 and/or third baffle 158 that is removable or adjustable to increase or decrease the amount of time the fluid being filtered by the construction sink 100 remains in the first section 146, second section 148, third section 150 and/or fourth section 152 of the tank portion 104, such that the user can adjust the filtration properties of the self-contained filtration system of the construction sink 100, if desired, according to the sediment content of the fluids being filtered or based on a user's specific needs.

Turning to the first section 146 of the tank portion 104, such first section 146 is defined by the walls 140 of the tank portion 104 and the first baffle 154 extending between and forming a fluid-impermeable barrier between opposing walls 140 of the internal cavity 136 of the tank portion 104. As illustrated, the first section 146 is located directly below the drain 114, such that contaminated fluid from cleaning tools in the sink 108 exits the sink via the drain 114 and into the first section 146 of the tank portion 104.

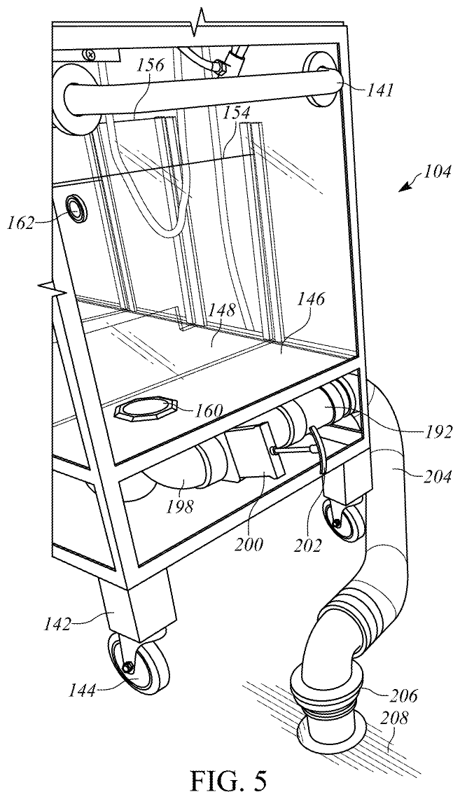

The construction sink 100 includes an opening 160 located at the gravitational bottom of the first section 146 that connects the first section 146 with a contaminant storage tank 198 underneath the tank portion 104 of the construction sink 100 (see FIG. 5). As will be understood, once the contaminated fluid enters the first section 146, gravitational forces will immediately begin to pull the larger sediment 179 toward the gravitational bottom of the first section 146 of the tank portion 104. The contaminant storage tank 198 provides a means to collect and store the larger sediment 179 that is filtered by the first section 146 by being pulled toward the gravitational bottom of the first section 146 of the tank portion 104.

As will be understood, including the opening 160 to the contaminant storage tank 198 at the gravitational bottom of the first section 146 provides the benefits of being able to use the construction sink 100 longer between cleanings by providing a place for the larger sediment 179 to be stored during use as well as by collecting the larger sediment 179 in a single location, allowing for easier removal of the larger sediment 179 from first section 146 after use.

Next, the second section 148 is defined by the walls 140 of the tank portion 104, the first baffle 154 extending between opposing walls 140 of the internal cavity 136 of the tank portion 104, and the second baffle 156 also extending between opposing walls 140 of the internal cavity 136 of the tank portion 104. Likewise, the third section 150 is defined by the walls 140 of the tank portion 104, the second baffle 156 extending between opposing walls 140 of the internal cavity 136 of the tank portion 104 and a third baffle 158 also extending between opposing walls 140 of the internal cavity 136 of the tank portion 140.

Of note, the second baffle 156 extends between opposing walls 140 of the internal cavity 136 of the tank portion 104 in such a manner that it provides an opening along the gravitational bottom of the tank portion 104 between the second section 148 and the third section 150. As will be discussed in detail later, this positioning of the second baffle 156 to provide an opening along the gravitational bottom of the second section 148 and third section 150 promotes the filtering of finer sediments 180 that may remain in the fluid entering the second section 148 of the tank portion 104 after the heavier sediments 179 have been filtered in the first section 146 of the tank portion 104.

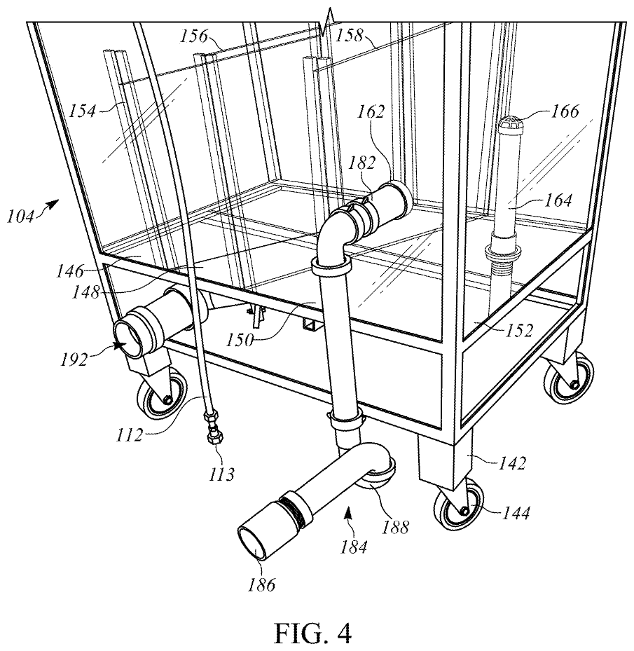

Turning to FIG. 4, a bottom perspective view of the construction sink 100 opposite the side shown in FIGS. 1 and 2 is shown. As illustrated, the fourth section 152 is defined by the walls 140 of the tank portion 104 and the third baffle 158 extending between and forming a fluid-impermeable barrier with opposing walls 140 of the internal cavity 136 of the tank portion 104 of the construction sink 100.

The fourth section 152 has a first drain 162 that extends through the wall 140 of the tank portion 104. The first drain 162 in the fourth section 152 can be coupled to a first end 182 of a drain pipe 184 and the second end 186 of the drain pipe 184 can be coupled to a drain line in a residential or commercial building, such as, but not limited to, the drain lines typically used by residential or commercial sinks. The drain pipe 184 also includes a P-Trap 188 for collecting any sediment that may remain in the filtered fluid before it enters the drain line of the commercial or residential building.

As will also be understood, after the drain pipe 184 has been disconnected from the first drain 162 in the fourth section 152 and the drain line of the residential and commercial building, a user can easily clean out the P-Trap 188 and remove any other sediment that may have been trapped in the drain pipe 184.

Also illustrated in FIG. 4, is a standpipe 164 located in the fourth section 152 having a second drain 166 that is located atop the standpipe 164. The second drain 166 atop the standpipe 164 in the fourth section 152 provides an additional means for fluid to be drained from the fourth section 152 through a second outlet 192 located below the tank portion 104 of the construction sink 100.

Turning to FIG. 5, a side perspective view opposite that illustrated in FIG. 4 showing the contaminant storage tank 198 connected to the first section 146 via the opening 160 located at the gravitational bottom of the tank portion 104 is illustrated. Downstream of the contaminant storage tank 198 is a waste valve 200 that includes a handle 202. The waste valve 200 can be any type of valve or barrier that provides a fluid-impermeable seal between the contaminant storage tank 198 and the second outlet 192.

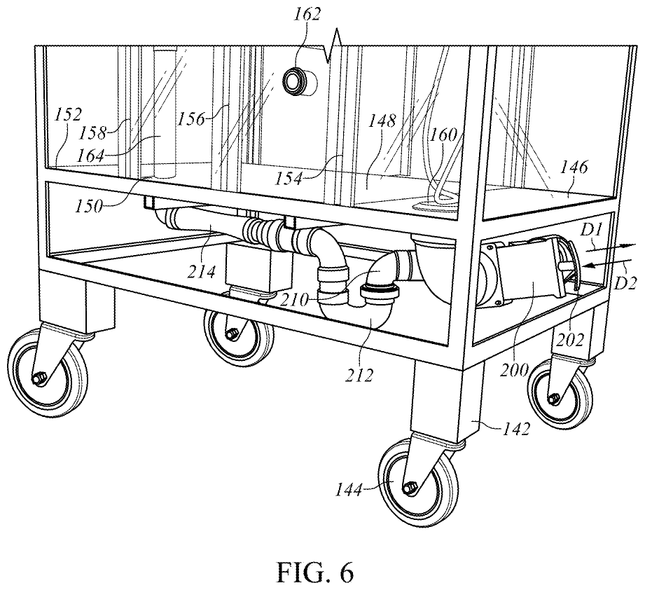

In one embodiment, the waste valve 200 can be a pull valve that can be opened by applying an axial force to the handle 202 of the waste valve 200 in a first direction D1 and be closed by applying an axial force on the handle 202 of the waste valve 200 in a second direction D2 (see FIG. 6).

In another embodiment, the waste valve 200 can be a twist waste valve which can be opened by rotating the handle 202 of the waste valve 200 in a first direction and the valve can be closed by rotating the handle 202 of the waste valve 200 in a second direction, opposite the first direction.

Turning back to FIG. 5, the second outlet 192 of the fourth section 152 connected to a drain pipe 204 that is connected to a drain line 206 on the floor 208 of a residential or commercial building, such as, but not limited to, the drain line of a toilet in a residential or commercial building is illustrated. With reference to FIGS. 5 & 6, the second outlet 192 is connected to the second drain 166 atop the drain pipe 164 in the fourth section 152 of the tank portion 104 via a first pipe section 210, a P-Trap 212, and a second pipe section 214.

Thus, depending on the needs of the user, the filtered fluid that enters the fourth section 152 of the tank portion 104 can be drained by the first drain 162 located through the wall 140 of the fourth section 152 or through the second drain 166 atop the drain pipe 164 in the fourth section 152. For example, if a user has access only to the drain line of a sink of a residential or commercial building the user can connect the fourth section 152 of the tank portion 104 to the drain using the first drain 162 (see FIG. 4). However, if the user has access only to the drain line of a toilet in a residential or commercial building the user can connect the fourth section 152 of the tank portion 104 to the drain through drain 166 atop the standpipe 166 and through the second outlet 192 (see FIGS. 5 & 6).

Next, to use the construction sink 100, a construction tool will be cleaned by a user with the fluid expelled from the faucet 110. The contaminated fluid will collect in the sink 108 before exiting the gravitational bottom of the sink 108 via the drain 114. As the contaminated fluid exits the drain 114 it enters the first section 146 of the tank portion 104.

In the first section 146, the heavier sediment 179 in the contaminated fluid will be pulled by gravity toward the gravitational bottom of the first section 146, where at least some of the heavier sediment 179 will enter the opening 160 located along the gravitational bottom of the first section 146 and collect in the sediment storage tank 198 below the tank portion 104 of the construction sink 100.

After enough fluid has been collected in the first section 146, the now partially filtered fluid will begin to flow over the top 168 of the first baffle 154 and into the second section 148 defined by opposing walls 140 of the internal cavity 136 of the storage tank 104 and the first baffle 154 and the second baffle 156. As the partially filtered fluid enters the second section 148, the finer sediment 180 remaining in the partially filtered fluid will collect on the gravitational bottom of the second section 148. Further, as the partially filtered fluid leaves the second section 148 and enters the third section 150, the second baffle 156 brings the partially filtered fluid towards the gravitational bottom of the tank portion 104.

As will be understood, including the opening of the second baffle 156 along the gravitational bottom of the tank portion 104 of the construction sink 100 increases the likelihood that the finer sediment 180 in the partially filtered fluid will settle along the gravitational bottom of the third section 150 of the tank portion 104 because to exit the third section 150 and flow over the top 172 of the third baffle 158 to enter the fourth section 154 of the tank portion 104, the finer sediment 180 will need to be fine enough to overcome the force of gravity acting to pull the finer sediment 180 towards the gravitational bottom of the third section 150.

Therefore, as will be understood, by including the opening of the second baffle 156 at the gravitational bottom of the tank portion 104 it is much more likely that the finer sediments 180 from the partially filtered fluid will not be able to overcome the force of gravity and flow over the top 172 of the third baffle 158 to enter the fourth section 152 of the tank portion 104 of the construction sink 100. Rather, in practice, almost all of the finer sediments 180 in the partially filtered fluid that enters the second section 148 will settle at the gravitational bottom of either the second section 148 or the third section 150 of the tank portion 104.

In other words, only the finest sediments 181 that remain in the partially filtered fluid that enter the second section 148 remain in the filtered fluid that ultimately flows over the top 172 of the third baffle 158 and into the fourth section 152, thereby making the filtered fluid entering the fourth section 152 of the tank portion 104 safe to dispose of using a common drain line of a typical residential or commercial building.

All references, including publications, patent applications and patents cited herein are hereby incorporated by reference to the same extent as if each reference were individually and specifically indicated to be incorporated by reference and were set forth in its entirety herein.

The use of the terms “a”, “an” and “the” and similar referents in the context of describing the invention (especially in the context of the following claims) is to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein.

The above-detailed description and the examples described therein have been presented for the purposes of illustration and description only and not by limitation. It is therefore contemplated that the present disclosure covers any and all modifications, variations or equivalents that fall within the spirit and scope of the basic underlying principles disclosed above and claimed herein.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A construction sink comprising:
a top portion defining a sink mechanically coupled to a bottom portion defining a tank, wherein the sink is in fluid communication with the tank;
the sink comprising a fluid line with a first end and a second end, wherein the fluid line is configured to connect to a fluid source at the first end and a faucet at the second end;
the sink further comprising a drain located at a gravitational bottom of the sink;
the tank having a first section defined by a first baffle, a second section defined by the first baffle and a second baffle, a third section defined by the second baffle and a third baffle, and a fourth section defined by the third baffle;
the fourth section further including an opening configured to connect to a drain line of a residential or commercial building;
wherein when fluid is expelled from the faucet a contaminated fluid is collected in the sink before entering the first section of the tank portion via the drain.

2. The construction sink of claim 1, wherein the first section includes an opening to a contaminant storage tank.

3. The construction sink of claim 1, wherein the fourth section includes a second drain configured to connect to a water outlet line of a residential or commercial building.

4. The construction sink of claim 1, wherein the second baffle provides an opening along the gravitational bottom of the tank portion, such that fluid is forced to flow along the gravitational bottom of the tank portion when exiting the second section and entering the third section of the tank portion.

5. The construction sink of claim 1, further comprising a tool cleaner having a body and a cover.

6. The construction sink of claim 1, wherein the first and third baffle do not provide an opening along the gravitational bottom of the tank portion.

7. The construction sink of claim 2, wherein the contaminant storage tank further comprises a valve that provides a fluid-impermeable seal between the contaminant storage tank and a second outlet.

8. The construction sink of claim 7, wherein the tool cleaner further comprises:
a nozzle extending into an internal cavity of the body and coupled to a fluid source, such that the nozzle can expel fluid into the internal cavity of the body; and
a drain to allow fluid expelled from the nozzle to exit the tool cleaner into the tank portion of the construction sink.

9. The construction sink of claim 7, wherein the drain of the tool cleaner is located at the gravitational bottom of the tool cleaner.

10. A portable construction sink comprising:
a faucet coupled to a pressurized fluid source;
a self-contained filtration system having a sink for collecting a fluid expelled from the pressurized fluid source by the faucet;
wherein the sink further comprises of a drain located at a gravitational bottom of the sink configured for draining the fluid into a tank portion of the construction sink;
the tank portion of the construction sink including a first section, a second section, a third section and a fourth section defined by a first baffle, a second baffle and a third baffle;
wherein the fourth section includes an outlet that can be coupled to a drain line in a residential or commercial building, such that fluid in the fourth section can be discharged from the drain of the construction sink into the drain line of the residential or commercial building.

11. The portable construction sink of claim 10, further comprising a tool cleaner including a body that defines an internal cavity, a cover and a coupling rod rotatably coupled to the cover, and a nozzle coupled to the pressurized fluid source that extends through the body of the tool cleaner and into the internal cavity of the tool cleaner.

12. The portable construction sink of claim 11, wherein a tool is removably configured to connect to the coupling rod of the tool cleaner.

13. The portable construction sink of claim 12, wherein the tool is a paint roller.

14. The portable construction sink of claim 11, wherein the coupling rod is rotatable about an axis of rotation in a first direction and a second direction while the coupling rod extends into an internal cavity of the tool cleaner.

15. The portable construction sink of claim 10, wherein the drain line in the residential or commercial building is a sink drain pipe.

16. The portable construction sink of claim 10, wherein the drain line of the residential or commercial building is a toilet drain pipe.

17. The portable construction sink of claim 10, further comprising a second drain in the fourth section, such that the construction sink can be configured to connect to both a sink drain line of a residential or commercial building and a toilet drain line of a residential or commercial building.

18. A method of filtering a contaminated fluid with a construction sink comprising the steps of:
connecting a first end of a fluid line to a pressurized fluid source and a second end of the fluid line to a faucet;
connecting a first end of a drain pipe to an opening in a tank portion of the construction sink and a second end of the drain pipe to a drainage line in a residential or commercial building;
actuating the faucet to expel a fluid from the pressurized fluid source;
cleaning a tool with the fluid from the pressurized clean fluid source;
collecting the fluid used to clean the tool in a sink;
draining the fluid used to clean the tool through a drain in the gravitational bottom of the sink;
collecting the fluid used to clean the tool in a first section of a tank portion of the construction sink;
filtering the fluid used to clean the tool through a first section defined by a first baffle, to a second section defined by the first baffle and a second baffle, to a third section defined by the second baffle and a third baffle, and to a fourth section defined by the third baffle;
collecting a filtered fluid in the fourth section of the tank portion; and
draining the filtered fluid through the outlet in the fourth section of the tank portion.

19. The method of filtering a contaminated fluid with a construction sink of claim 18, wherein the first section includes an opening connected to a contaminant storage tank.

20. The method of filtering a contaminated fluid with a construction sink of claim 18, wherein the second baffle forms an opening between the second section and the third section along the gravitational bottom of the tank portion.
